(19) United States
(12) Patent Application Publication
(10) Pub. No.: US 2009/0016535 A1
(43) Pub. Date: Jan. 15, 2009

(54) Fuzzy Keys

(75) Inventor: Russell Paul Cowburn, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: INGENIA HOLDINGS (UK) LIMITED, London (GB)

(21) Appl. No.: 12/139,238

(22) Filed: Jun. 13, 2008

Related U.S. Application Data
(60) Provisional application No. 60/943,801, filed on Jun. 13, 2007.

(30) Foreign Application Priority Data
Jun. 13, 2007 (GB) 0711461.4

(51) Int. Cl. H04L 9/06

(52) U.S. Cl. 380/277

(57) ABSTRACT

A method can be provided for performing encryption using a fuzzy key. The method can comprise generating a message, dividing a fuzzy key into a plurality of blocks; and generating an encrypted message by selecting a block from the fuzzy key corresponding to a bit position or bit pattern in the message.

### FIELD

The present invention relates to fuzzy keys, and in particular but not exclusively, to performance of encryption operations using fuzzy keys.

### BACKGROUND

In many applications where secure transmission of data is required, data encryption can be used to impede unauthorised access to that data. Conventional encryption schemes work on one of two methods: symmetric and asymmetric key methods.

Symmetric key systems use the same key for encryption and decryption of data. Thus the key must be distributed between participants in an exchange of encrypted data. If the key is not distributed securely, it is possible for third parties to obtain a copy of the key and to use that copy to access all data encrypted using the key.

Asymmetric key systems work on a one way encryption scheme where a public key is used to encrypt data, which can then only be decrypted using a private key which is kept by the recipient of the data. Thus the public key can be freely distributed and anything encrypted using the key can only be decrypted using the private key. However in such a system, it can still be desirable that the public key is distributed such that a person receiving the public key can be certain that it comes from the intended recipient of a secure communication. If this is not the case, there is a possibility of a third party creating a public key which appears to belong to someone else and using that public key and its corresponding private key to access encrypted data intended for the apparent originator of the key.

It is generally recognised that fuzzy keys, such as those derived from biometric signatures and biometric-type signatures make poor encryption keys due to the very low likelihood of the signature generation process returning exactly the same signature twice. In many biometric type systems, a “match” is declared based on a predetermined minimum number of bits from a signature matching. Depending upon the system and the application, this threshold may be as low as 70% bit match rate or as high as 95% bit match rate. Clearly such a low bit match ratio could lead to significant errors when performing decryption of an encrypted message.

A data packaging technique has been discussed in Gershenfeld, Science 297 (5589): 20026-2030, Sep. 20, 2002. The technique disclosed thereby uses a very specific optically transparent three-dimensional token to create wrapping data.

One known data packaging technique using fuzzy keys is an XOR based system developed by Feng Hao, Ross Anderson and John Daugman, “Combining Crypto with Biometrics Effectively”, IEEE Trans on Computers, vol. 55, no. 9, pp/1081-1088, September 2006. This system has a particular disadvantage that it is very susceptible to errors caused by stretch in an article (stretch is also an apparent effect in some signature generation systems if a signature source article is moving non-linearly relative to a signature measuring system). Using this technique if the distortion caused by the stretch (or movement) is greater than the autocorrelation width of the data in the signature, then at least 50% of matches will be lost.

### SUMMARY

The inventor has recognised the limitations of fuzzy signatures as encryption keys and presents a method and associated apparatus for addressing those limitations to provide an effective encryption scheme.

Viewed from one aspect, the present invention can provide a method for performing encryption using a fuzzy key. According to this method, a message can be encrypted using a fuzzy key which has been divided into a plurality of blocks. The encrypted message can be generated by selecting a block from the fuzzy key corresponding to a bit position or bit pattern in the message. Thus a block of the fuzzy key corresponds to each bit or bit group within the message. Thus the relatively low bit match rate which may occur between two separately generated biometric signatures from the same source can be countered to avoid errors occurring.

As a system utilising the above method can be expected to add considerably to the length of the message by application of the encryption, it may be appropriate in some circumstances to use this method to distribute as the “message” a key for another encryption scheme. The message may therefore be a session key for a symmetric encryption algorithm. Symmetric encryption algorithms have the advantage of being less demanding of processing power than asymmetric encryption algorithms and so may typically be used for the bulk data transfer in a secure data exchange, once the keys have been securely distributed (for example by the above method). The message may alternatively be a public key for an asymmetric encryption algorithm. Thus the above method can be used to securely distribute a public key for later use in establishing secure communications based on a symmetric encryption algorithm, the symmetric session key being exchanged between parties using the previously distributed public key. Thereby a two-tier key distribution system may be employed.

In some examples, error correction coding can be added to the message prior to encryption, thereby providing for the message to be double-checked and, if necessary, corrected following an eventual decryption process.

In some examples, the message is a session key for a symmetrical encryption algorithm or a public key for an asymmetric encryption algorithm. Thus the encryption method of the present examples can be used to initiate a secure communication channel using a conventional and computationally fast encryption method.

In some examples, the fuzzy key is a biometric type signature derived from a physical property of an article or living being. In some examples, the biometric type signature is representative of a surface texture of an identifier article. By using a biometric type signature, the security of the system can be enhanced by ensuring that only the correct living being or owner of the correct article can decrypt the message.

In some examples, method further comprises dividing a second fuzzy key into a plurality of blocks, wherein the number of blocks of the first and second fuzzy keys is equal to or greater than the number of bits in the message, and wherein the generating comprises, for each respective bit of the message selecting between the respective blocks of the first and second fuzzy keys in dependence upon the value of the bit of the message. Thereby, a single bit of the message can be represented by a group of bits of the encrypted message, thus providing resilience against noise and distortion of the transmitted encrypted message, and providing resilience against the fuzzyness of the keys.

In some examples, the second fuzzy key is the bitwise logical NOT of the first fuzzy key. Thus a decryption process can choose between correlation and anti-correlation when decrypting the message, providing a largest possible distinction between matching and non-matching key blocks.

In some examples, the first and second fuzzy keys are created from different regions of a single identifier article. Thus a decryption process can be performed based upon a complete and intact identifier article, thus enhancing security.

In some examples, the method further comprises dividing the message into blocks of n bits each. Also, the number of blocks of the fuzzy key is determined as 2ⁿ and each block is associated with the n bit block number. Wherein the generating is performed by selecting for each block in the message, the block from the fuzzy key having the block number corresponding to the bit pattern of the message block. Thus each block of the key can be large and thus resilient to noise or distortion of the transmitted encrypted message, and resilient to the fuzzyness of the keys.

Viewed from a second aspect, there can be provided a system for performing encryption using a fuzzy key. The system can comprise a key handler operable to divide a fuzzy key into a plurality of blocks; and a generator operable to generate an encrypted message by selecting a block from the fuzzy key corresponding to a bit position or bit pattern in a message to be encrypted. Thus a block of the fuzzy key corresponds to each bit or bit group within the message. Thus the relatively low bit match rate which may occur between two separately generated biometric signatures from the same source can be countered to avoid errors occurring.

Viewed from another aspect, there can be provided a method for performing decryption using a fuzzy key. The method can comprise receiving a message encrypted using a fuzzy key, dividing a fuzzy key generated from the same source as a fuzzy key used to encrypt the message into a plurality of blocks; and comparing each block of the received message to a respective block of the fuzzy key to determine a value for a bit position or bit pattern in the message. Thus a block of the fuzzy key corresponds to each bit or bit group within the message. Thus the relatively low bit match rate which may occur between two separately generated biometric signatures from the same source can be countered to avoid errors occurring.

Viewed from a further aspect, there can be provided a system for performing decryption using a fuzzy key. The system can comprise a receiver operable to receive a message encrypted using a fuzzy key, a key handler operable to divide a fuzzy key generated from the same source as a fuzzy key used to encrypt the message into a plurality of blocks; and a comparator operable to compare each block of the received message to a respective block of the fuzzy key to determine a value for a bit position or bit pattern in the message. Thus a block of the fuzzy key corresponds to each bit or bit group within the message. Thus the relatively low bit match rate which may occur between two separately generated biometric signatures from the same source can be countered to avoid errors occurring.

Viewed from a further aspect, there can be provided a method for transmitting a message. The method can comprise, encrypting a message according to any of the methods set out above, transmitting the encrypted message, and decrypting the message according to any of the methods set out above.

Viewed from another aspect, there can be provided a system for transmitting a message. The system can comprise an encryption system according to any of systems set out above, a transmission channel operable to carry the encrypted message, and a decryption system according to any of the systems set out above.

Further aspects and embodiments will be apparent from the specific description which follows hereafter.

### BRIEF DESCRIPTION OF THE FIGURES

Specific embodiments of the present invention will now be described by way of example only with reference to the accompanying figures in which:

FIG. 1 shows a schematic side view of a reader apparatus;

FIG. 2 shows a block schematic diagram of functional components of the reader apparatus;

FIG. 3 is a microscope image of a paper surface;

FIG. 4 shows an equivalent image for a plastic surface;

FIG. 5 shows a flow diagram showing how a signature of an article can be generated from a scan;

FIG. 6 shows a flow diagram depicting logical steps in encrypting a message;

FIG. 7 shows example of various blocks involved in the encryption process;

FIG. 8 shows a flow diagram depicting logical steps in encrypting a message; and

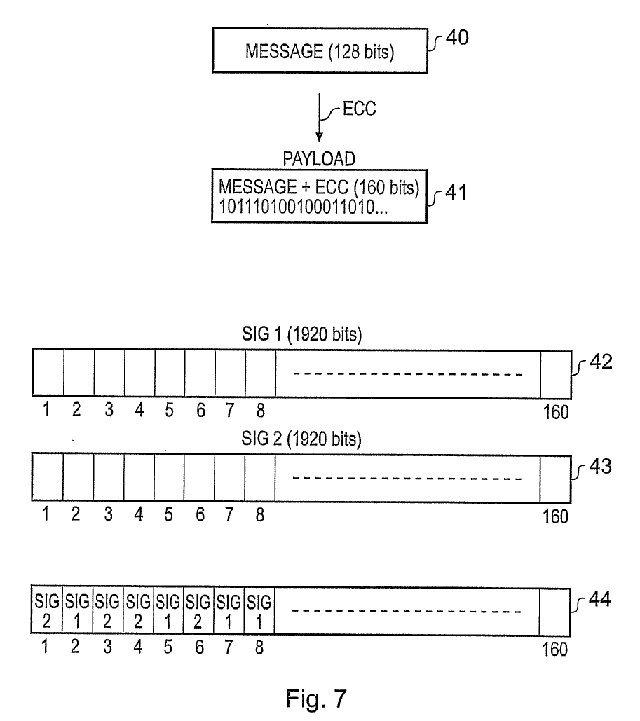

FIG. 7 shows example of various blocks involved in the encryption process.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DESCRIPTION OF PARTICULAR EMBODIMENTS

The systems and methods described herein for use of fuzzy keys and signatures in encryption type systems can be applied to any system which generates a fuzzy key or signature. Many such systems are biometric or biometric-type systems. Biometric systems may generate a key/signature by processing data captured from a scan of a biological feature, such as a human fingerprint, retina or iris. Biometric-type systems may generate a key/signature by processing data captured from a scan of a non-biological feature exhibiting random patterning or structure, such as a microscopically rough paper or plastic surface.

Examples of systems for generating a biometric signature are those used in commercially available electronic fingerprint access systems, such as those used in some portable computers and fingerprint keyed electronic locks. Such systems typically operate by taking measurements of the pattern, electrical conductivity etc of a fingerprint at certain predetermined points and comparing them to a stored template to determine whether a match has occurred.

Examples of systems for generating a biometric type signature are those used to identify physical tokens of some variety. Many such systems rely upon random distribution of particulate material within a substrate to give a characteristic response to a given stimulus (e.g. illumination of the token). Another system for generating a biometric type signature is that developed and marketed by Ingenia Technologies Ltd. This system is operable to analyse the random surface patterning of a paper, cardboard, plastic or metal article, such as a sheet of paper, an identity card or passport, a security seal, a payment card etc to uniquely identify a given article. This system is described in detail in a number of published patent applications, including GB0405641.2 filed 12 Mar. 2004 (published as GB2411954 14 Sep. 2005), GB0418138.4 filed 13 Aug. 2004 (published as GB2417707 8 Mar. 2006), US60/601,464 filed 13 Aug. 2004, US60/601,463 filed 13 Aug. 2004, US60/610,075 filed 15 Sep. 2004, GB 0418178.0 filed 13 Aug. 2004 (published as GB2417074 15 Feb. 2006), U.S. 60/601,219 filed 13 Aug. 2004, GB 0418173.1 filed 13 Aug. 2004 (published as GB2417592 01 Mar. 2006), U.S. 60/601,500 filed 13 Aug. 2004, GB 0509635.9 filed 11 May 2005 (published as GB2426100 15 Nov. 2006), U.S. 60/679,892 filed 11 May 2005, GB 0515464.6 filed 27 Jul. 2005 (published as GB2428846 7 Feb. 2007), U.S. 60/702,746 filed 27 Jul. 2005, GB 0515461.2 filed 27 Jul. 2005 (published as GB2429096 14 Feb. 2007), U.S. 60/702,946 filed 27 Jul. 2005, GB 0515465.3 filed 27 Jul. 2005 (published as GB2429092 14 Feb. 2007), U.S. 60/702,897 filed 27 Jul. 2005, GB 0515463.8 filed 27 Jul. 2005 (published as GB2428948 7 Feb. 2007), U.S. 60/702,742 filed 27 Jul. 2005, GB 0515460.4 filed 27 Jul. 2005 (published as GB2429095 14 Feb. 2007), U.S. 60/702,732 filed 27 Jul. 2005, GB 0515462.0 filed 27 Jul. 2005 (published as GB2429097 14 Feb. 2007), U.S. 60/704,354 filed 27 Jul. 2005, GB 0518342.1 filed 8 Sep. 2005 (published as GB2429950 14 Mar. 2007), U.S. 60/715,044 filed 8 Sep. 2005, GB 0522037.1 filed 28 Oct. 2005 (published as GB2431759 2 May 2007), and U.S. 60/731,531 filed 28 Oct. 2005 (all invented by Cowburn et al.), the content of each and all of which is hereby incorporated hereinto by reference.

By way of illustration, a brief description of the method of operation of the Ingenia Technologies Ltd system will now be presented.

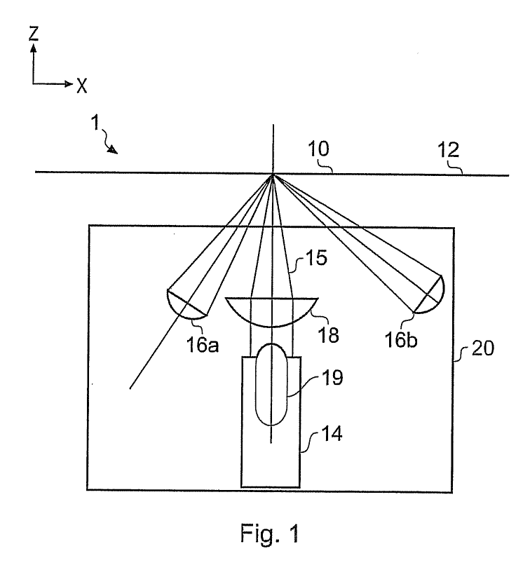

FIG. 1 shows a schematic side view of a reader apparatus 1. The optical reader apparatus 1 is for measuring a signature from an article (not shown) arranged in a reading volume of the apparatus. The reading volume is formed by a reading aperture 10 which is a slit in a housing 12. The housing 12 contains the main optical components of the apparatus. The slit has its major extent in the x direction (see inset axes in the drawing). The principal optical components are a laser source 14 for generating a coherent laser beam 15 and a detector arrangement 16 made up of a plurality of k photodetector elements, where k=2 in this example, labelled 16a and 16b. The laser beam 15 is focused by a focussing arrangement 18 into an elongate focus extending in the y direction (perpendicular to the plane of the drawing) and lying in the plane of the reading aperture. In one example reader, the elongate focus has a major axis dimension of about 2 mm and a minor axis dimension of about 40 micrometres. These optical components are contained in a subassembly 20. In the illustrated example, the detector elements 16a, 16b are distributed either side of the beam axis offset at different angles from the beam axis to collect light scattered in reflection from an article present in the reading volume. In one example, the offset angles are −30 and +50 degrees. The angles either side of the beam axis can be chosen so as not to be equal so that the data points they collect are as independent as possible. However, in practice, it has been determined that this is not essential to the operation and having detectors at equal angles either side of the incident beam is a perfectly workable arrangement. All four detector elements are arranged in a common plane. The photodetector elements 16a and 16b detect light scattered from an article placed on the housing when the coherent beam scatters from the reading volume. As illustrated, the source is mounted to direct the laser beam 15 with its beam axis in the z direction, so that it will strike an article in the reading aperture at normal incidence.

Generally it is desirable that the depth of focus is large, so that any differences in the article positioning in the z direction do not result in significant changes in the size of the beam in the plane of the reading aperture. In one example, the depth of focus is approximately ±2 mm which is sufficiently large to produce good results. In other arrangements, the depth of focus may be greater or smaller. The parameters, of depth of focus, numerical aperture and working distance are interdependent, resulting in a well known trade off between spot size and depth of focus. In some arrangements, the focus may be adjustable and in conjunction with a rangefinding means the focus may be adjusted to target an article placed within an available focus range.

In order to enable a number of points on the target article to be read, the article and reader apparatus can be arranged so as to permit the incident beam and associated detectors to move relative to the target article. This can be arranged by moving the article, the scanner assembly or both. In some examples, the article may be held in place adjacent the reader apparatus housing and the scanner assembly may move within the reader apparatus to cause this movement. Alternatively, the article may be moved past the scanner assembly, for example in the case of a production line where an article moves past a fixed position scanner while the article travels along a conveyor. In other alternatives, both article and scanner may be kept stationary, while a directional focus means causes the coherent light beam to travel across the target. This may require the detectors to move with the light bean, or stationary detectors may be positioned so as to receive reflections from all incident positions of the light beam on the target.

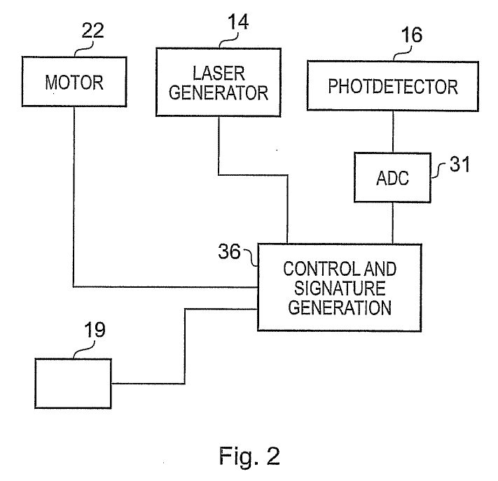

FIG. 2 is a block schematic diagram of logical components of a reader apparatus as discussed above. A laser generator 14 is controlled by a control and signature generation unit 36. Optionally, a motor 22 may also be controlled by the control and signature generation unit 36. Optionally, if some form of motion detection or linearization means (shown as 19) is implemented to measure motion of the target past the reader apparatus, and/or to measure and thus account for non-linearities in there relative movement, this can be controlled using the control and signature generation unit 36.

The reflections of the laser beam from the target surface scan area are detected by the photodetector 16. As discussed above, more than one photodetector may be provided in some examples. The output from the photodetector 16 is digitised by an analog to digital converter (ADC) 31 before being passed to the control and signature generation unit 36 for processing to create a signature for a particular target surface scan area. The ADC can be part of a data capture circuit, or it can be a separate unit, or it can be integrated into a microcontroller or microprocessor of the control and signature generation unit 36.

The control and signature generation unit 36 can use the laser beam present incidence location information to determine the scan area location for each set of photodetector reflection information. Thereby a signature based on all or selected parts of the scanned part of the scan area can be created. Where less than the entire scan area is being included in the signature, the signature generation unit 36 can simply ignore any data received from other parts of the scan area when generating the signature. Alternatively, where the data from the entire scan area is used for another purpose, such as positioning or gathering of image-type data from the target, the entire data set can be used by the control and signature generation unit 36 for that additional purpose and then kept or discarded following completion of that additional purpose.

As will be appreciated, the various logical elements depicted in FIG. 2 may be physically embodied in a variety of apparatus combinations. For example, in some situations, all of the elements may be included within a scan apparatus. In other situations, the scan apparatus may include only the laser generator 14, motor 22 (if any) and photodetector 16 with all the remaining elements being located in a separate physical unit or units. Other combinations of physical distribution of the logical elements can also be used. Also, the control and signature generation unit 36 may be split into separate physical units. For example, the there may be a first unit which actually controls the laser generator 14 and motor (if any), a second unit which calculates the laser beam current incidence location information, a third unit which identifies the scan data which is to be used for generating a signature, and a fourth part which actually calculates the signature.

It will be appreciated that some or all of the processing steps carried out by the ADC 31 and/or control and signature generation unit 36 may be carried out using a dedicated processing arrangement such as an application specific integrated circuit (ASIC) or a dedicated analog processing circuit. Alternatively or in addition, some or all of the processing steps carried out by the beam ADC 31 and/or control and signature generation unit 36 may be carried out using a programmable processing apparatus such as a digital signal processor or multi-purpose processor such as may be used in a conventional personal computer, portable computer, handheld computer (e.g. a personal digital assistant or PDA) or a smartphone. Where a programmable processing apparatus is used, it will be understood that a software program or programs may be used to cause the programmable apparatus to carry out the desired functions. Such software programs may be embodied onto a carrier medium such as a magnetic or optical disc or onto a signal for transmission over a data communications channel.

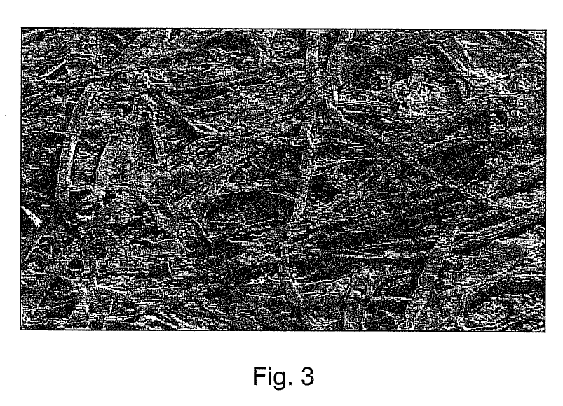

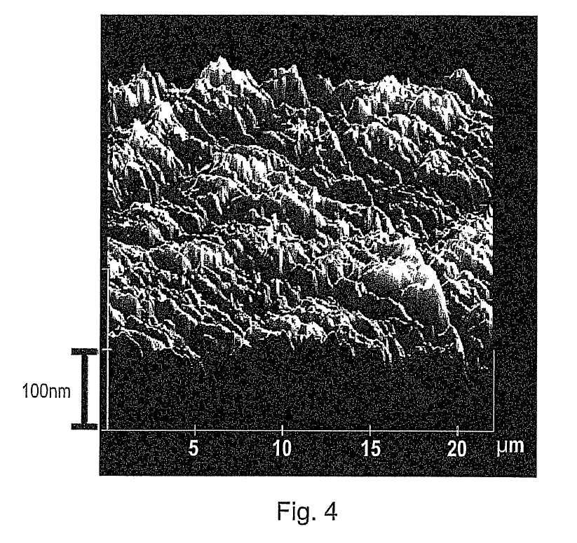

To illustrate the surface properties which the system of these examples can read, FIGS. 3 and 4 illustrate a paper and plastic article surface respectively.

FIG. 3 is a microscope image of a paper surface with the image covering an area of approximately 0.5×0.2 mm. This figure is included to illustrate that macroscopically flat surfaces, such as from paper, are in many cases highly structured at a microscopic scale. For paper, the surface is microscopically highly structured as a result of the intermeshed network of wood or other plant-derived fibres that make up paper. The figure is also illustrative of the characteristic length scale for the wood fibres which is around 10 microns. This dimension has the correct relationship to the optical wavelength of the coherent beam to cause diffraction and also diffuse scattering which has a profile that depends upon the fibre orientation. It will thus be appreciated that if a reader is to be designed for a specific class of goods, the wavelength of the laser can be tailored to the structure feature size of the class of goods to be scanned. It is also evident from the figure that the local surface structure of each piece of paper will be unique in that it depends on how the individual wood fibres are arranged. A piece of paper is thus no different from a specially created token, such as the special resin tokens or magnetic material deposits of the prior art, in that it has structure which is unique as a result of it being made by a process governed by laws of nature. The same applies to many other types of article.

FIG. 4 shows an equivalent image for a plastic surface. This atomic force microscopy image clearly shows the uneven surface of the macroscopically smooth plastic surface. As can be surmised from the figure, this surface is smoother than the paper surface illustrated in FIG. 3, but even this level of surface undulation can be uniquely identified using the signature generation scheme of the present examples.

In other words, it is essentially pointless to go to the effort and expense of making specially prepared tokens, when unique characteristics are measurable in a straightforward manner from a wide variety of every day articles. The data collection and numerical processing of a scatter signal that takes advantage of the natural structure of an article's surface (or interior in the case of transmission) is now described.

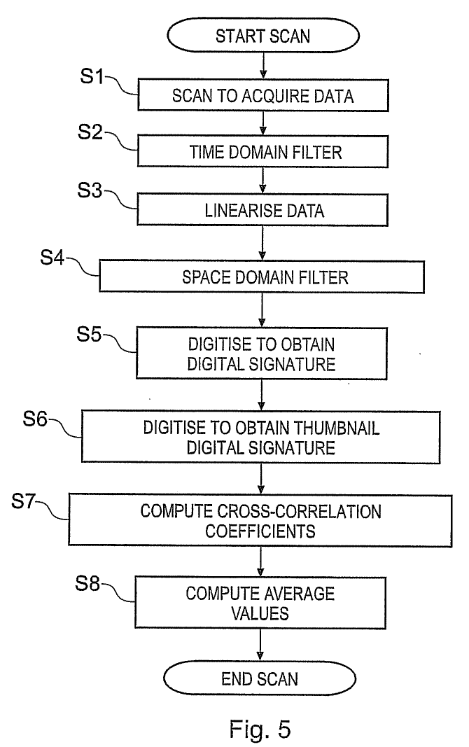

FIG. 5 shows a flow diagram showing how a signature of an article can be generated from a scan.

Step S1 is a data acquisition step during which the optical intensity at each of the photodetectors is acquired at a number of locations along the entire length of scan. Simultaneously, the encoder signal is acquired as a function of time. It is noted that if the scan motor has a high degree of linearisation accuracy (e.g. as would a stepper motor), or if non-linearities in the data can be removed through block-wise analysis or template matching, then linearisation of the data may not be required. Referring to FIG. 2 above, the data is acquired by the signature generator 36 taking data from the ADC 31. The number of data points per photodetector collected in each scan is defined as N in the following. Further, the value aₖ(i) is defined as the i-th stored intensity value from photodetector k, where i runs from 1 to N.

Step S2 is an optional step of applying a time-domain filter to the captured data. In the present example, this is used to selectively remove signals in the 50/60 Hz and 100/120 Hz bands such as might be expected to appear if the target is also subject to illumination from sources other than the coherent beam. These frequencies are those most commonly used for driving room lighting such as fluorescent lighting.

Step S3 performs alignment of the data. In some examples, this step uses numerical interpolation to locally expand and contract aₖ(i) so that the encoder transitions are evenly spaced in time. This corrects for local variations in the motor speed and other non-linearities in the data. This step can be performed by the signature generator 36.

In some examples, where the scan area corresponds to a predetermined pattern template, the captured data can be compared to the known template and translational and/or rotational adjustments applied to the captured data to align the data to the template. Also, stretching and contracting adjustments may be applied to the captured data to align it to the template in circumstances where passage of the scan head relative to the article differs from that from which the template was constructed. Thus if the template is constructed using a linear scan speed, the scan data can be adjusted to match the template if the scan data was conducted with non-linearities of speed present.

Step S4 applies a space-domain band-pass filter to the captured data. This filter passes a range of wavelengths in the x-direction (the direction of movement of the scan head). The filter is designed to maximise decay between samples and maintain a high number of degrees of freedom within the data. With this in mind, the lower limit of the filter passband is set to have a fast decay. This is required as the absolute intensity value from the target surface is uninteresting from the point of view of signature generation, whereas the variation between areas of apparently similar intensity is of interest. However, the decay is not set to be too fast, as doing so can reduce the randomness of the signal, thereby reducing the degrees of freedom in the captured data. The upper limit can be set high; whilst there may be some high frequency noise or a requirement for some averaging (smearing) between values in the x-direction (much as was discussed above for values in the y-direction), there is typically no need for anything other than a high upper limit. In some examples a 2^{nd} order filter can be used. In one example, where the speed of travel of the laser over the target surface is 20 mm per second, the filter may have an impulse rise distance 100 microns and an impulse fall distance of 500 microns.

Instead of applying a simple filter, it may be desirable to weight different parts of the filter. In one example, the weighting applied is substantial, such that a triangular passband is created to introduce the equivalent of realspace functions such as differentiation. A differentiation type effect may be useful for highly structured surfaces, as it can serve to attenuate correlated contributions (e.g. from surface printing on the target) from the signal relative to uncorrelated contributions.

Step S5 is a digitisation step where the multi-level digital signal (the processed output from the ADC) is converted to a bi-state digital signal to compute a digital signature representative of the scan. The digital signature is obtained in the present example by applying the rule: aₖ(i)>mean maps onto binary ‘1’ and aₖ(i)<=mean maps onto binary ‘0’. The digitised data set is defined as dₖ(i) where i runs from 1 to N. The signature of the article may advantageously incorporate further components in addition to the digitised signature of the intensity data just described. These further optional signature components are now described.

Step S6 is an optional step in which a smaller ‘thumbnail’ digital signature is created. In some examples, this can be a realspace thumbnail produced either by averaging together adjacent groups of m readings, or by picking every cth data point, where c is the compression factor of the thumbnail. The latter may be preferable since averaging may disproportionately amplify noise. In other examples, the thumbnail can be based on a Fast Fourier Transform of some or all of the signature data. The same digitisation rule used in Step S5 is then applied to the reduced data set. The thumbnail digitisation is defined as tₖ(i) where i runs 1 to N/c and c is the compression factor.

Step S7 is an optional step applicable when multiple detector channels exist (i.e. where k>1). The additional component is a cross-correlation component calculated between the intensity data obtained from different ones of the photodetectors. With 2 channels there is one possible cross-correlation coefficient, with 3 channels up to 3, and with 4 channels up to 6 etc. The cross-correlation coefficients can be useful, since it has been found that they are good indicators of material type. For example, for a particular type of document, such as a passport of a given type, or laser printer paper, the cross-correlation coefficients always appear to lie in predictable ranges. A normalised cross-correlation can be calculated between aₖ(i) and aₗ(i), where k≠l and k,l vary across all of the photodetector channel numbers. The normalised cross-correlation function is defined as:

$$Γ ( k , l ) = \frac{{\sum }_{i = 1}^{N} {a}_{k} ( i ) {a}_{l} ( i )}{\sqrt{( {\sum }_{i = 1}^{N} {{a}_{k} ( i )}^{2} ) ( {\sum }_{i = 1}^{N} {{a}_{l} ( i )}^{2} )}}$$

Another aspect of the cross-correlation function that can be stored for use in later verification is the width of the peak in the cross-correlation function, for example the full width half maximum (FWHM). The use of the cross-correlation coefficients in verification processing is described further below.

Step S8 is another optional step which is to compute a simple intensity average value indicative of the signal intensity distribution. This may be an overall average of each of the mean values for the different detectors or an average for each detector, such as a root mean square (rms) value of aₖ(i). If the detectors are arranged in pairs either side of normal incidence as in the reader described above, an average for each pair of detectors may be used. The intensity value has been found to be a good crude filter for material type, since it is a simple indication of overall reflectivity and roughness of the sample. For example, one can use as the intensity value the unnormalised rms value after removal of the average value, i.e. the DC background. The rms value provides an indication of the reflectivity of the surface, in that the rms value is related to the surface roughness.

Thus an example of a system for obtaining a biometric-type signature from an article has been briefly described. For more details of this type of system, the reader is directed to consider the content of the various published patent applications identified above.

One thing that is consistent between biometric signatures and biometric-type signatures is that the output from two scans of the same biological characteristic/physical article will almost never produce exactly the same result. For this reason, determining a match result within a biometric or biometric-type system is often referred to as a fuzzy match in that a match result is determined based upon a confidence criterion, rather than a 100% bit correspondence between the two signatures as is often the case in a digital environment.

Depending upon the type of signature being created, the method of signature creation and the application for which the signature is being used, a match result may be declared when the result of a comparison between two signatures (typically a test signature and a record signature) yields a comparison result exceeding a predetermined threshold. Such a comparison may be performed by a cross-correlation or other comparison algorithm, and the result of such may be expressed as a bit match rate or similar. In an example implementation of the Ingenia Technology Ltd system, a signature for a cardboard packaging item may be 2000 bits in length and a bit match rate threshold in the range of 70-95% may be set for determining a match result.

Such fuzzy match systems therefore work on the basis of a fuzzy signature, which if used in the context of an encryption system may be considered to be a fuzzy key. However, almost all encryption systems require bit-perfect keys to operate correctly. Otherwise the decrypted message will not match the encrypted message and data loss will have occurred.

The following examples detail various approaches for using a fuzzy key to encrypt a message in a robust manner which avoids the conventionally experienced problems associated with using such fuzzy keys.

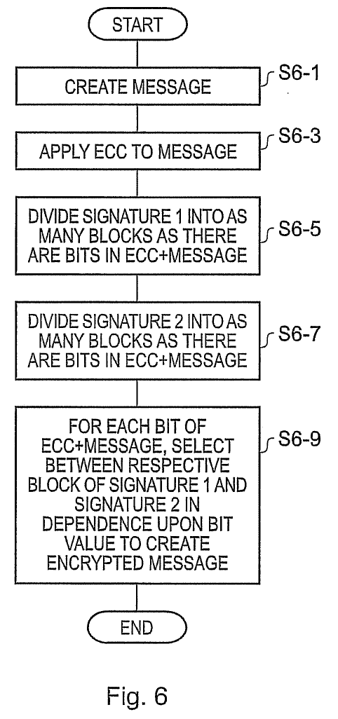

A first example is shown in FIG. 6. In this flow chart, the major logical steps in encrypting a message according to this first example are set out. Starting at step S6-1, the message to be encrypted is generated. Next, and optionally, error correction coding is applied to the message at step S6-3. The error correction coding may be any suitable technique, such as a simple technique such as a cyclical redundancy check, or a more complex error correction scheme such as a hamming code, BCH code, Reed-Solomon code, Reed-Muller code, binary Golay code, convolutional code, or turbo code.

A first biometric or biometric-type signature (signature1) is then divided into a number of blocks equal to the number of bits in the message (with error correction code bits if applied) at step S6-5. This same process is also carried out on a second biometric or biometric-type signature (signature2) at step S6-7.

Then, in order to create the encrypted message, for each bit of the message, the respective block of either signature1 or signature2 is selected. Selecting between signature1 and signature2 is done according to the bit value. If the bit value is “0” then the respective block of signature1 may be selected, and if bit value is “1” then the respective block of signature2 may be selected. Thus an encrypted message comprising a sequence of data blocks is created. The length of encrypted message of the present example is therefore the same as the length of the signatures (assuming that the signatures are the same length. If the signatures are different lengths, then the blocks of one will be larger than the blocks of the other and the encrypted message will have a length intermediate the lengths of the two signatures. Thus an encrypted message is created using the biometric/biometric type signatures.

To decrypt the message, the signatures for the same two articles/features are required. For each block of the encrypted message, the block is compared to the respective block of both signatures. The bit value of the original message is thus determined by which signature's block matches best to the block of the encrypted message.

Thus it will be understood that the aspect of this example which overcomes the conventionally experienced difficulties with fuzzy keys is that by using multiple bits (i.e. a block) from the fuzzy signature for each bit of the message, no single bit of the signature is individually responsible for the value of a bit in the message. This, coupled with the decryption process which simply looks for a best match between two alternatives (rather than an absolute recovered value), allows the fuzzy signature to be used as an encryption key without concern for lost or garbled data caused by the fuzzyness of the key.

As will be appreciated, the method of this example is best suited to short messages, and in any case to messages having fewer bits than the signature. In general, and depending upon the degree of fuzzyness of the particular parameter used as the key, it is desirable for each block of the signature to have a minimum length of approximately 10 bits. The upper limit for the length of each block is simply set by the operating environment of the system and the maximum signature size that can be generated and manipulated.

The restrictions on a system of this type to short messages relative to the signature length lends the system of this example to being particularly suitable for transporting a session key for a symmetrical encryption algorithm. As symmetrical encryption algorithms are by far the fastest (in processing resource demand terms) encryption algorithms currently known, it is considered to be beneficial to distribute a symmetrical algorithm key using the system of this example, so that further data transfer can be carried out using the symmetrical encryption algorithm. Alternatively, the payload message of this example may be a public key of an asymmetric encryption algorithm. Thus the public key can be distributed in a manner that guarantees to the recipient that it came from a party with whom it intends to communicate securely. The public key can then be used to establish secure communications. In some examples, it would be possible for that asymmetric system to be used in turn to distribute a symmetric system session key which could then be used to establish a secure communications channel.

An example of the various blocks is shown in FIG. 7 with some specific example data length figures.

A message 40 is to be encrypted. In the present example, this is a 128 bit randomly generated session key for a symmetrical encryption algorithm, although other messages can be used. Error correction coding is then applied to the message. In this example the error correction coding is reed-solomon coding, but other codings may be used. This creates a total payload length of 160 bits (shown as 41).

Separately, a first signature 42 (signature1) is divided into 160 blocks (one for each bit of the payload). In the present example, the signature length is 1920 bits (such that each block is 12 bits long). A second signature 43 is also divided into 160 blocks. In the present example, the signature length and number of blocks have been selected so as to provide that the signature length is an integer multiple of the no of blocks. This is easily achieved in the systems of the present examples as the length of the signature can be set to any desired size. In other examples, it would be possible to have a signature length which is not an integer multiple of the no of blocks. In such examples, it would simply be the case that some blocks contain a different number of bits to the remaining blocks. Such a situation would not reduce or impair the operational performance of the system.

The two divided signatures 42 and 43 are then used to create the encrypted message using the payload as a gate. In the present example, if the payload bit value is “0”, then the respective block of signature1 is used in the encrypted message. Similarly, if the payload bit value is “1”, then the respective block of signature2 is used in the encrypted message.

This is illustrated in FIG. 7, where an example bit sequence of the first few bits of the payload is illustrated at 41. Thus it is clear that as the first bit value of the payload 41 is “1”, the first block of the encrypted message 44 is the first block of signature 2. The second bit value of the payload 41 is “0”, the first block of the encrypted message 44 is the first block of signature 1. This is applied for every bit of the payload until the encrypted message 44 is complete.

For decryption, the reverse applies. Thus the two signatures are created—these will typically be at a different location, made from the same article or biological feature, so while they will be similar to the original signatures signature1 and signature2, what will in fact be present are signature1′ and signature 2′. These will each be divided into the 160 blocks as on the encryption side. Each block of the received encrypted message will then be compared by a cross-correlation process to the pairs of respective blocks from signature1′ and signature 2′. Thus each block of the received encrypted message is compared to a pair of blocks, the ones having the same block number from each of signature1 and signature 2′, by shifting the blocks relative to one another and obtaining a cross-correlation comparison result for each bit position tested. The highest (peak) cross-correlation result from comparison to the block of each of signature1 and signature 2′ is selected as the best result for that comparison. The best result from the comparison to signature1 is then compared to the best result from the comparison to signature 2′. It would normally be expected that for most blocks there will be a marked difference between the results of the comparisons against signature1 and signature 2′ as one result should represent correlation, and the other non-correlation, although for some bit patterns this may appear to be correlation and partial correlation. The higher of these two values represents the test block which returns the best match result when tested against the encrypted message block and is thus selected as the correct block, and a bit value of the respective bit of the decrypted payload is selected thereby. As before, if the best matching block is from signature1′, then the bit value is determined to be “0”, and if the best matching block is from signature2′, then the bit value is determined to be “1”. Thus the payload is recovered.

At this stage the error correction coding scheme can be used to identify and correct any errors that did occur due to either transmission introduced errors or incorrect match results from the fuzzy key process, such that the original message (the session key) can be recovered.

As will thus be seen, a two stage process can be used to recover the original payload. The first of these is the fuzzy match result obtained from the cross-correlation of the blocks of the transmitted signature. This performs the decryption and retrieves the payload. However, depending upon factors such as the channel error rate for the channel which carried the message it is possible that some blocks may have been incorrectly decoded by the cross-correlation process. Thus, in addition to the fast and generally accurate fuzzy match process, an error correction coding scheme can be used in conjunction with the original payload. Thus this error correction coding can be used to identify and correct any bit values in the recovered payload that were decoded incorrectly by the fuzzy match process. This system therefore provides great efficiency by relying on the relatively fast and accurate fuzzy match process, and then optionally uses a backup error correction coding scheme to identify any mismatches from the fuzzy match system for maximum possible accuracy.

Tests performed using the example data length figures from the example of FIG. 7 have revealed an operational accuracy ratio of the order of at least 1:1,000,000 in terms of false positive and false negative results, where the bit error rate between multiple signatures generated from the same article is 30% (i.e. only 70% bit match rate—usually at the lower limit of acceptability for any biometric/biometric type signature system).

Although the above has described the use of signature 1 and signature 2, these do not need to be completely separate signatures. For example, they could be first and second parts of the same signature. In the event that the signatures are completely separate, they may both be obtained from the same source or from different sources. For example, the signatures could be from two different parts of an ID card, from two different ID cards, from a fingerprint and an ID card, from two different fingerprints or from a fingerprint and an iris scan. Al that is really required is that the signatures are different—which is basically guaranteed in a biometric or biometric-type signature based system.

In one example, signature1 and signature 2 are both from the same data. Rather than using two different signatures, or even using different parts of the same signature, in this example signature2 is the inverse (bitwise logical NOT) of signature1. Thus, every bit of signature 2 has the opposite value to the equivalent bit of signature1. By using this approach, the distinction between the two different signatures at the decryption stage is expected to be especially strong as there is in fact anti-correlation between the two signatures. Thus the task of selecting between the two candidate blocks for any given block of the encrypted message should be as easy as is possible for a system of this type.

Considering the decryption process in more detail, a signature is created from the same article or biological feature. Thus while they the newly created signature will be similar to the original signature signature1, what will in fact be present is signature1′. This will then be divided into the 160 blocks as on the encryption side. As with the previous example, the test block is cross correlated against signature1′. However, as noted above, in this example there is no signature2, simply signature1 and its inverse, so cross-correlation only needs to be performed once for each test block. In contrast to the above example, where the test was between correlation and non-correlation, the test in this example is between correlation and anti-correlation. Thus, for each comparison test block, a cross-correlation is performed between the test block and the respective block of signature1′. For this cross-correlation operation, the maximum and minimum value peaks are used to determine the match. The magnitude of the largest positive peak and the magnitude of the largest negative peak are compared, and the largest magnitude is considered to be the best match. Thereby the system can select between the signature and the inverse signature to determine whether the block represents a “0” or a “1”.

The approach detailed in these examples is resistant to distortions in the article or feature from which the signature is produced. For example, if an ID card from which a signature is generated is flexible or stretchable, then two signatures generated from the same ID card may be have a variable offset between bits therein due to distortions between the ID card at the different times of the scan. This can also be a concern where an article of paper or cardboard is used to generate the signature, as it may become stretched or otherwise distorted, for example by becoming wet. Even if such distortions occur, the block-based coding used by this system reduces the effect of such distortions to avoid failure of a message to be decrypted.

Thus there has now been described a method for using a fuzzy key for encryption of a message and subsequently reliably recovering the message using a new fuzzy key generated from the same identifier article or biological feature at a decryption location.

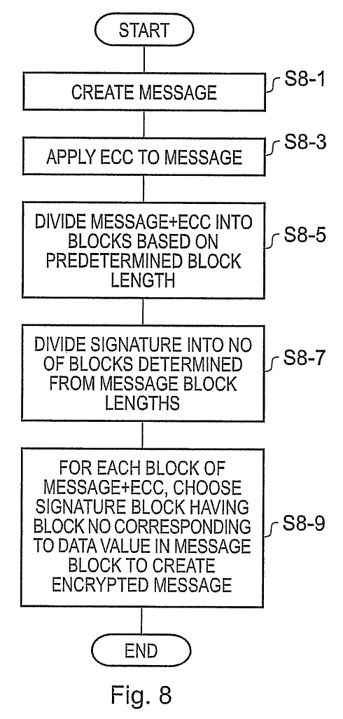

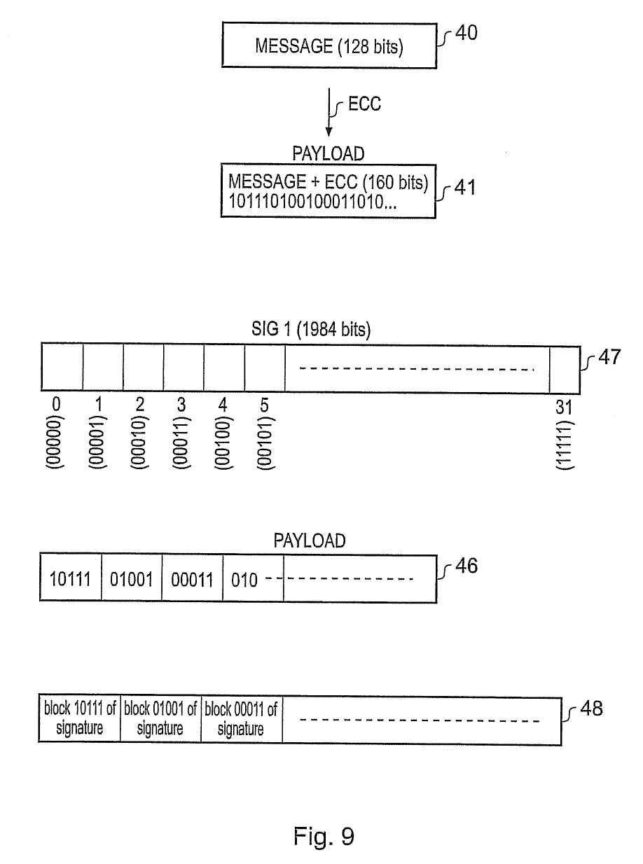

Another example of a method for using a fuzzy key to encrypt a message in a robust manner which avoids the conventionally experienced problems associated with using such fuzzy keys is illustrated in FIG. 8.

FIG. 8 shows a flowchart in which the major logical steps in encrypting a message according to this second example are set out. Starting at step S8-1, the message to be encrypted is generated. Next, and optionally, error correction coding is applied to the message at step S8-3. The error correction coding may be any suitable technique, such as a simple technique such as a cyclical redundancy check, or a more complex error correction scheme such as a hamming code, BCH code, Reed-Solomon code, Reed-Muller code, binary Golay code, convolutional code, or turbo code.

The message (with error correction code bits if applied) is then divided into blocks of a predetermined length at step S8-5. A biometric or biometric-type signature is then divided into a number of blocks equal to the maximum numerical value which can be represented by a binary number having a length equal to the predetermined message block length at step S8-7.

Then, in order to create the encrypted message, for each block of the message, a block of the signature is selected by choosing the signature block having a block number equal to the numerical value of the data in the message block. Thus an encrypted message is created using the biometric/biometric type signatures.

To decrypt the message, a signature from the same article/feature is required, and the signature is divided into the same number of blocks as for the encryption process. For each block of the encrypted message, the block is compared to the signature to find the position of the block within the signature. This will correspond to a block number within the signature, which block number in turn reveals the data values of the original message. The bit values of the original message are thus determined by which signature block matches best to the block of the encrypted message.

Thus it will be understood that the aspect of this example which overcomes the conventionally experienced difficulties with fuzzy keys is that by using multiple bits (i.e. a block) from the fuzzy signature for each block of the message, no single bit of the signature is individually responsible for the value of a bit in the message. This, coupled with the decryption process which simply looks for a best match between two alternatives (rather than an absolute recovered value), allows the fuzzy signature to be used as an encryption key without concern for lost or garbled data caused by the fuzzyness of the key.

As will be appreciated, the method of this example is best suited to short messages. However, the restriction on the message to be shorter than the signature experienced by the previously described examples is not present here. On the other hand, the nature of this system means that as the message length increases, the chance of any given signature block being repeated increases. It will be appreciated that a large number of block repeats in the encrypted message may be undesirable from an absolute security viewpoint. Therefore, it is generally desirable that message transmitted using this system are kept short.

The preference for a system of this type to short messages lends the system of this example to being particularly suitable for transporting a session key for a symmetrical encryption algorithm. As symmetrical encryption algorithms are by far the fastest (in processing resource demand terms) encryption algorithms currently known, it is considered to be beneficial to distribute a symmetrical algorithm key using the system of this example, so that further data transfer can be carried out using the symmetrical encryption algorithm. Alternatively, the payload message of this example may be a public key of an asymmetric encryption algorithm. Thus the public key can be distributed in a manner that guarantees to the recipient that it came from a party with whom it intends to communicate securely. The public key can then be used to establish secure communications, possible for that asymmetric system to be used to distribute a symmetric system session key.

An example of the various blocks is shown in FIG. 9 with some specific example data length figures.

As in the previous examples, a message 40 is to be encrypted. In the present example, this is a 128 bit randomly generated session key for a symmetrical encryption algorithm, although other messages can be used. Error correction coding is then applied to the message. In this example the error correction coding is reed-solomon coding, but other codings may be used. This creates a total payload length of 160 bits (shown as 41). Shown at 46, the payload is divided into blocks of a predetermined length. In the present example, this predetermined length is 5 bits.

Separately, a signature 47 is created and is divided into blocks, the number of blocks being determined by the block length for the payload. In the present example of a payload block length of 5 bits, the maximum number representable using 5 bits is 32. Thus the signature is divided into block 0 to 31 (00000 to 11111 in binary representation). In other example, other payload block lengths may be adopted, leading to different numbers of signature blocks. In the present example, the signature is 1984 bits in length so as to an integer multiple of the number of blocks. As explained above, if the signature length is not an integer multiple of the number of blocks, some blocks will be 1 bit longer than the remainder. As before, such a situation would not negatively affect the operation of the system. Thus, in the present example, each block will be 62 bits long (1984÷32).

The divided signature 47 is then used to create the encrypted message using the numerical value of the data in each payload block as an index. Thus, in the example shown in FIG. 9, the first block of the payload has data values 10111, this means that block 23 (the numerical value of the data in the payload block) of the signature is the first block of the encrypted message 48. The second block of the payload has data values 01001 such that block 9 (the numerical value of the data in the payload block) of the signature is the second block of the encrypted message 48. This process is continued until the encrypted message 48 is complete.

For decryption, the reverse applies. Thus the signature is created—this will typically be at a different location, made from the same article or biological feature, so while it will be similar to the original signature, what will in fact be present is signature′. This will be divided into the 32 blocks as on the encryption side. Then each block of the received encrypted message will then be compared to signature′. The block position in signature′ at which the best match occurs is determined, and the block number of that best match signature block then represents the data value of the payload block. This comparison may be a simple comparison, or may be more complex, for example a cross-correlation between the encrypted message block and each individual block of signature′. If such is used, then it is relatively straightforward to discriminate between an encrypted message block that fits well to the signature but at a position overlapping two blocks and also at a position with greater correspondence to a single block. In the example of FIG. 9, the comparison of the first block of the encrypted message 48 to signature′ will reveal that the best match occurs against block 23 of signature′. Thus it is known that the data values of the first block of the payload are 10111 (the binary representation of the number 23). Thus the payload is recovered. At this stage the error correction coding scheme can be used to identify and correct any errors that did occur due to either transmission introduced errors or incorrect match results from the fuzzy key process, such that the original message (the session key) can be recovered.

With this example, there is particularly good resistance to the “fuzzyness” of the signature as a relatively long signature block represents each payload block. On the other hand, it is necessary to attempt to detect and correct any offset between signature and signature′ before the comparison is made. This is necessary to attempt to prevent false matches at an incorrect part of signature′.

The approach detailed in the above examples is resistant to distortions in the article or feature from which the signature is produced. For example, if an ID card from which a signature is generated is flexible or stretchable, then two signatures generated from the same ID card may be have a variable offset between bits therein due to distortions between the ID card at the different times of the scan. This can also be a concern where an article of paper or cardboard is used to generate the signature, as it may become stretched or otherwise distorted, for example by becoming wet. Even if such distortions occur, the block-based coding used by this system reduces the effect of such distortions to avoid failure of a message to be decrypted.

Thus there has now been described a method for using a fuzzy key for encryption of a message and subsequently reliably recovering the message using a new fuzzy key generated from the same identifier article or biological feature at a decryption location.

Thus there have now been described a number of methods for using a fuzzy key for message encryption without a risk of the fuzzy nature of the key leading to data loss or distortion in a decrypted message.

1. A method for performing encryption using a fuzzy key, the method comprising:
generating a message;
dividing a fuzzy key into a plurality of blocks;
generating an encrypted message by selecting a block from the fuzzy key corresponding to a bit position or bit pattern in the message.

2. The method of claim 1, wherein the generating comprises selecting for each bit position value or bit pattern in the message a different block from the fuzzy key, on the basis of the value at the bit position or on the basis of a predetermined association with the bit pattern.

3. The method of claim 1, further comprising adding error correction coding to the message prior to encryption.

4. The method of claim 1, wherein the message is a session key for a symmetrical encryption algorithm or a public key for an asymmetric encryption algorithm.

5. The method of claim 1, wherein the fuzzy key is a biometric type signature.

6. The method of claim 5, wherein the biometric type signature is representative of a surface texture of an identifier article.

7. The method of claim 1, further comprising:
dividing a second fuzzy key into a plurality of blocks;
wherein the number of blocks of the first and second fuzzy keys is equal to or greater than the number of bits in the message, and wherein the generating comprises, for each respective bit of the message selecting between the respective blocks of the first and second fuzzy keys in dependence upon the value of the bit of the message.

8. The method of claim 7, wherein the second fuzzy key is the bitwise logical NOT of the first fuzzy key.

9. The method of claim 7, wherein the first and second fuzzy keys are created from different regions of a single identifier article.

10. The method claim 1, further comprising:
dividing the message into blocks of n bits each;
wherein the number of blocks of the fuzzy key is determined as 2ⁿ and each block is associated with the n bit block number; and
wherein the generating is performed by selecting for each block in the message, the block from the fuzzy key having the block number corresponding to the bit pattern of the message block.

11. A system for performing encryption using a fuzzy key, the system comprising:
a key handler operable to divide a fuzzy key into a plurality of blocks; and
a generator operable to generate an encrypted message by selecting a block from the fuzzy key corresponding to a bit position or bit pattern in a message to be encrypted.

12. The system of claim 11, further comprising an error correction generator operable to add error correction coding to the message prior to encryption.

13. The system of claim 11, wherein the message is a session key for a symmetrical encryption algorithm or a public key for an asymmetric encryption algorithm.

14. The system of claim 11, wherein the fuzzy key is a biometric type signature.

15. The system of claim 14, wherein the biometric type signature is representative of a surface texture of an identifier article.

16. The system of claim 11, wherein:
the key handler is further operable to divide a second fuzzy key into a plurality of blocks;
wherein the number of blocks of the first and second fuzzy keys is equal to or greater than the number of bits in the message, and wherein the generator or operable, for each respective bit of the message to select between the respective blocks of the first and second fuzzy keys in dependence upon the value of the bit of the message.

17. The system of claim 16, wherein the second fuzzy key is the bitwise logical NOT of the first fuzzy key.

18. The system of claim 16, wherein the first and second fuzzy keys are created from different regions of a single identifier article.

19. The system of claim 11, wherein:
the key handler is operable to divide the message into blocks of n bits each;
wherein the number of blocks of the fuzzy key is determined as 2ⁿ and each block is associated with the n bit block number; and
wherein the generator is operable to select for each block in the message, the block from the fuzzy key having the block number corresponding to the bit pattern of the message block.

20. A method for performing decryption using a fuzzy key, the method comprising:
receiving a message encrypted using a fuzzy key;
dividing a fuzzy key generated from the same source as a fuzzy key used to encrypt the message into a plurality of blocks; and
comparing each block of the received message to a respective block of the fuzzy key to determine a value for a bit position or bit pattern in the message.

21. The method of claim 20, further comprising performing error correction processing on the message following decryption.

22. The method of claim 20, wherein the message is a session key for a symmetrical encryption algorithm or a public key for an asymmetric encryption algorithm.

23. The method of claim 20, wherein the fuzzy key is a biometric type signature.

24. The method of claim 23, wherein the biometric type signature is representative of a surface texture of an identifier article.

25. The method of claim 20, further comprising:
dividing a second fuzzy key generated from the same source as a fuzzy key used to encrypt the message into a plurality of blocks;
wherein the number of blocks of the first and second fuzzy keys is equal to or greater than the number of bits in the message, and wherein the comparing comprises, for each respective block of the encrypted message selecting between the respective blocks of the first and second fuzzy keys in dependence upon a comparison result between the encrypted message block and each fuzzy key block, wherein the bit value of the message bit is determined in dependence upon the selected fuzzy key block.

26. The method of claim 25, wherein the second fuzzy key is the bitwise logical NOT of the first fuzzy key.

27. The method of claim 25, wherein the first and second fuzzy keys are created from different regions of a single identifier article.

28. The method of claim 20, wherein the comparing further comprises comparing a block of the encrypted message to each block of the fuzzy key to determine a best match block from the fuzzy key, wherein the value of a bit pattern in the message is recovered as being the block number of the best match block form the fuzzy key.

29. A system for performing decryption using a fuzzy key, the system comprising:
a receiver operable to receive a message encrypted using a fuzzy key;
a key handler operable to divide a fuzzy key generated from the same source as a fuzzy key used to encrypt the message into a plurality of blocks; and
a comparator operable to compare each block of the received message to a respective block of the fuzzy key to determine a value for a bit position or bit pattern in the message.

30. The system of claim 29, further comprising an error correction processor operable to perform error correction processing on the message following decryption.

31. The system of claim 29, wherein the message is a session key for a symmetrical encryption algorithm or a public key for an asymmetric encryption algorithm.

32. The system of claim 29, wherein the fuzzy key is a biometric type signature.

33. The system of claim 32, wherein the biometric type signature is representative of a surface texture of an identifier article.

34. The system of claim 29, wherein:
the key handler is operable to divide a second fuzzy key generated from the same source as a fuzzy key used to encrypt the message into a plurality of blocks;
wherein the number of blocks of the first and second fuzzy keys is equal to or greater than the number of bits in the message, and wherein the comparator is operable to, for each respective block of the encrypted message select between the respective blocks of the first and second fuzzy keys in dependence upon a comparison result between the encrypted message block and each fuzzy key block, wherein the bit value of the message bit is determined in dependence upon the selected fuzzy key block.

35. The system of claim 34, wherein the second fuzzy key is the bitwise logical NOT of the first fuzzy key.

36. The system of claim 34, wherein the first and second fuzzy keys are created from different regions of a single identifier article.

37. The system of claim 34, wherein the comparator is operable to compare a block of the encrypted message to each block of the fuzzy key to determine a best match block from the fuzzy key, wherein the value of a bit pattern in the message is recovered as being the block number of the best match block form the fuzzy key.

38. A method for transmitting a message, the method comprising:
encrypting a message using a fuzzy key, the encrypting comprising dividing a fuzzy key into a plurality of blocks, and generating an encrypted message by selecting a block from the fuzzy key corresponding to a bit position or bit pattern in the message;
transmitting the encrypted message; and
decrypting the message using a fuzzy key, the decrypting comprising dividing a fuzzy key, generated from the same source as the fuzzy key used to encrypt the message, into a plurality of blocks, and comparing each block of the received message to a respective block of the fuzzy key to determine a value for a bit position or bit pattern in the message.
